(19) United States
(12) Patent Application Publication
(10) Pub. No.: US 2011/0102795 A1
(43) Pub. Date: May 5, 2011

(54) Carbon nanotube/polydiacetylene composites

(76) Inventors: Huisheng Peng, Shanghai (CN); Dean E. Peterson, Santa Fe, NM (US); Yuntian T. Zhu, Cary, NC (US); Quanxi Jia, Los Alamos, NM (US)

(21) Appl. No.: 12/807,040

(22) Filed: Aug. 25, 2010

Related U.S. Application Data
(60) Provisional application No. 61/275,133, filed on Aug. 25, 2009.

(51) Int. Cl. G01J 3/46; G02B 5/23; G01N 25/00

(52) U.S. Cl. 356/402; 252/586; 73/865.8

(57) ABSTRACT

Chromatic materials such as polydiacetylene change color in response to a wide variety of environmental stimuli including changes in temperature, pH and chemical or mechanical stress, and have been extensively explored as sensing devices. Here is reported the facile synthesis of carbon nanotube/polydiacetylene nanocomposite fibers which rapidly and reversibly respond to electrical current, with the resulting color change being readily observable with the naked eye. These composite fibers also chromatically respond to a broad spectrum of other stimulations: for example, they exhibit rapid and reversible stress-induced chromatism with negligible elongation.

Nanotube/polydiacetylene nanocomposite fibers could have various applications in sensing.

### RELATED APPLICATIONS

This application claims priority to U.S. Provisional Application No. 61/275,133, filed on Aug. 25, 2009.

The present invention relates to composites and more particularly relates to composites of carbon nanotubes and a polymer such as polydiacetylene. The United States government has rights in this invention pursuant to Contract No. DE-AC52-06NA25396 between the United States Department of Energy and Los Alamos National Security, LLC for the operation of Los Alamos National Laboratory.

### FIELD OF THE INVENTION

### Background of the Invention

Conjugated polymers have been investigated for a number of applications in optoelectronics and sensing because the extended π-electron delocalization along their backbones endows them with useful electronic and optical properties. For instance, polydiacetylene (PDA) typically changes color from blue to red under various external stimuli (including interactions with ligands or changes in temperature, pH, chemical or mechanical stress), and has been explored as a material for chromatic sensors. This color change is caused by the conformation change of the PDA as a result of these stimuli. More precisely, the increased motional freedom of the PDA side chains caused by the stimuli leads to a more disordered (and less coplanar) polymer structure with a shorter conjugation length. Significant efforts have been already made to add new sensing functionalities to PDA but, to the best of our knowledge, no current-induced color change has ever been reported for this material. Although it is difficult to induce conformation changes of pure PDA under electric fields, current-induced chromatic behavior in PDA could have applications in the non-destructive evaluation and monitoring of structures ranging from aircraft to small electronic facilities.

A possible and convenient approach to solve the above dilemma is formation of nanocomposites. If one phase produces electric fields which are strong enough to induce conformation changes of incorporated PDA molecules at nanoscale when passed with current, the collective effects may macroscopically reflect color changes. One of the ideal candidates to meet this requirement is carbon nanotube (CNT). As already extensively explored, nanotubes show excellent electrical conductivities. For instance, long nanotube arrays have been synthesized recently through chemical vapor deposition, and conductivity of individual multi-walled nanotubes can be as high as 104 S/cm at room temperature. These nanotubes may be spun into macroscopic fibers while maintaining excellent electrical properties. Therefore, it is the objective of this study to produce new CNT/PDA composite with current-induced chromatic changes.

### SUMMARY OF THE INVENTION

To achieve the foregoing and other objects, and in accordance with the purposes of the present invention, as embodied and broadly described herein, the present invention provides a composite including carbon nanotube fibers, and, a polydiacetylene.

In another embodiment, the present invention, provides sensor including a composite of carbon nanotube fibers and a polydiacetylene, said composite subject to a detectable change in response to a stimuli from among temperature, pH, chemical exposure, mechanical stress, and, a means of measuring the detectable change.

### BRIEF DESCRIPTION OF THE DRAWINGS

FIGS. 1(a) to 1(c) show characterization of carbon nanotubes used to make the CNT/PDA fiber composites in accordance with the present invention. In FIG. 1(a), is a digital representation of a scanning electron microscopy (SEM) image. In FIG. 1(b), is a digital representation of a high resolution transmission electron microscopy (TEM) image. In FIG. 1(c), a typical Raman spectrum showing D-band at 1345 cm⁻¹ and G-band at 1577 cm⁻¹.

FIG. 2 shows a digital representation of SEM images of a composite CNT/PDA fiber with different magnifications and shows that the nanotubes are highly aligned in fibers.

FIG. 3 shows electrical properties of a CNT/PDA fiber composite with temperature dependence of conductivity measured by a four-probe method in accordance with the present invention.

FIGS. 4(a) and 4(b) show various chromatic transitions of a composite CNT/PDA fiber in response to an electric current in accordance with the present invention. In FIG. 4(a), is shown a schematic illustration with the color of the CNT/PDA fiber composite changing from blue to red when a current is passed through it in a two-probe experiment. In FIG. 4(b), passing a dc current of 10 mA through a CNT/PDA fiber composite (diameter of 11 im) causes a blue fiber (top left) to become red after 1 second (top middle). The current is turned off after 3 seconds (bottom left), and the fiber becomes blue again after a further 2 seconds (bottom right). Silver paint was used to hold the CNT/PDA fiber composites in place and to connect to the external current sources. All experiments were performed at room temperature.

FIG. 5 shows a schematic illustration of the synthesis of nanotube arrays through chemical vapor deposition.

FIG. 6 shows a schematic illustration of topochemical polymerization and color changes of resultant PDA.

FIG. 7 shows typical UV-vis spectra for blue PDA (line 70) and red PDA (line 72).

FIG. 8 shows the electrical properties of the CNT/PDA fiber composites and the scaling of the conductivity with the three-dimensional hopping model on a plot of 1n a vs. T^{-1/4}.

FIG. 9 shows electrical properties of a CNT/PDA fiber composite in accordance with the present invention with temperature dependence of conductivity measured by a four-probe method.

FIG. 10 shows the thermochromatism of PDA derived from CH₃(CH₂)₁₁C≡C—C≡C(CH₂)₈COOH.

FIG. 11 shows characterization on temperature change of the carbon nanotube fiber when current is passed as digital representation of optical microscopy images before and after a current of 30 mA was passed for one minute.

FIG. 12 shows mechanical properties of CNT/PDA fiber composites in accordance with the present invention where stress-strain curves of three CNT/PDA fiber composites indicated negligible elongation.

FIG. 13 shows color changes of CNT/PDA fiber composites under mechanical stress where solid blue line (130) is the as-synthesized blue PDA material, solid red line (132) is the CNT/PDA fiber composite under mechanical stress of 0.48 GPa and dashed blue line (134) is for the recovery of the CNT/PDA fiber composite from red to blue after the removal of the stress.

FIG. 14 shows as digital representations of images the characterization of color change on the CNT/PDA fiber composites from blue to red under mechanical abrasion.

FIG. 15 shows UV-vis spectra of CNT/PDA fiber composites before and after exposure to various chemicals.

FIG. 16 UV-vis spectra of CNT/PDA fiber composites before and after exposure to various chemical vapors.

### DETAILED DESCRIPTION

The present invention concerns composites of carbon nanotubes and a polymer such as polydiacetylene.

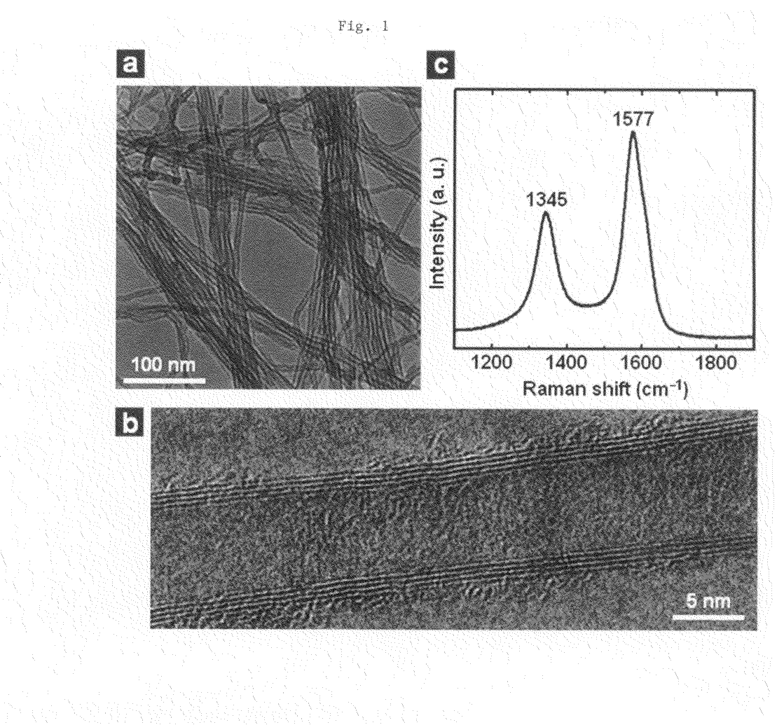

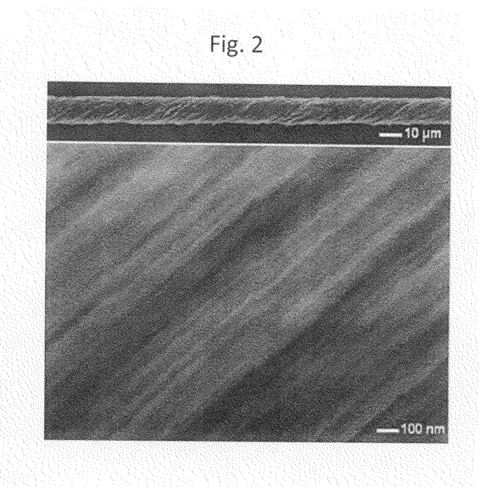

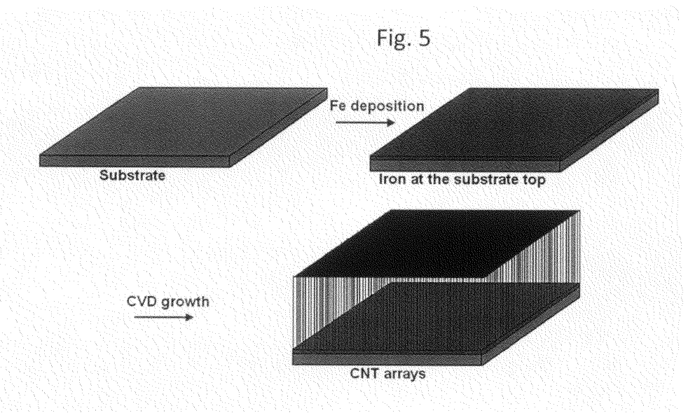

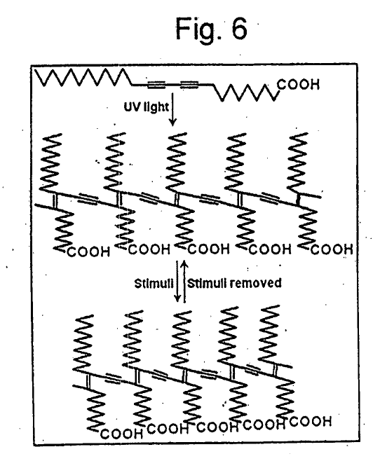

Pure nanotube fibers are spun from nanotube arrays which are synthesized by a chemical vapor deposition process (see FIG. 5). Diameters of nanotube fibers can be controlled from 4 to 20 μm, depending on initial ribbon widths during the spinning process. Ribbon is defined as a bunch of nanotubes pulled out of nanotube array at the beginning of the spinning process. Transmission electron microscopy (TEM, see FIG. 1a) and high resolution TEM (see FIG. 1b) indicate multi-walled structure for these nanotubes with diameter of ˜10 nm. Representative Raman spectrum (see FIG. 1c) shows a weak peak at 1345 cm⁻¹ for D-band and a strong peak at 1577 cm⁻¹ for G-band, similar to other reported multi-walled nanotubes. Composite CNT/PDA fibers were then synthesized by directly coating diacetylenic precursors, e.g., CH₃(CH₂)₁₁C≡C—C≡C(CH₂)₈COOH, onto nanotubes, followed by topochemical polymerization of diacetylenic moieties under UV light (see FIG. 6). Also, FIG. 2 shows an SEM image of a CNT/PDA fiber with uniform size of 11 μm along the axial direction. As-synthesized CNT/PDA fibers are blue and can be readily observed by the naked eye.

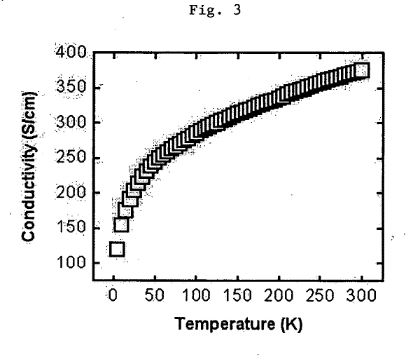

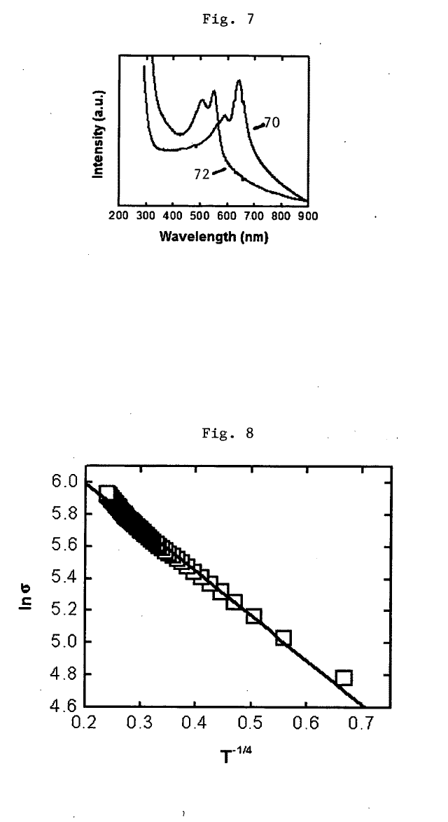

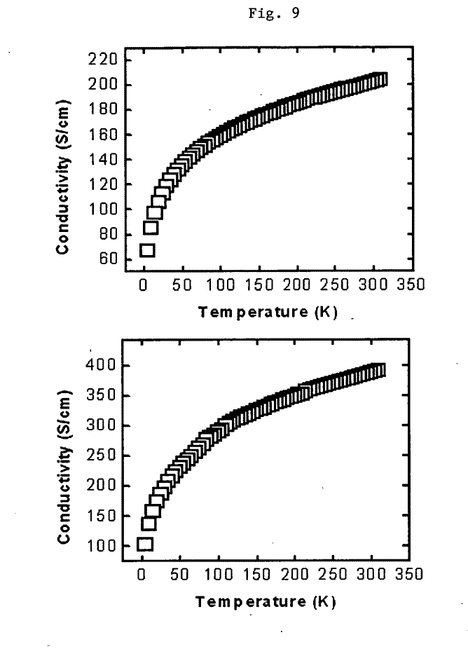

CNT/PDA fibers exhibit high conductivities of 102-103 S/cm due to alignment of nanotubes inside. Temperature dependence of conductivities of CNT/PDA fibers was further investigated by a four-probe approach. As shown in FIGS. 3 and 9, conductivity increases with increasing temperature, which indicates a semiconducting behavior in CNT/PDA fibers. Two main conduction models, i.e., variable range hopping mechanism and tunneling conduction mechanism, may be applicable to these composite fibers. According to previously reported method, electron transport of CNT/PDA fiber is found to be more consistent with three-dimensional hopping mechanism (FIG. 8). In other words, electrons could not be confined in one-dimensional channel along nanotube-aligned direction when passed with current. Instead, electrons possibly hop from one localized site to another or from a nanotube to another. The above behavior is most likely produced by nanotube defects in composite fibers.

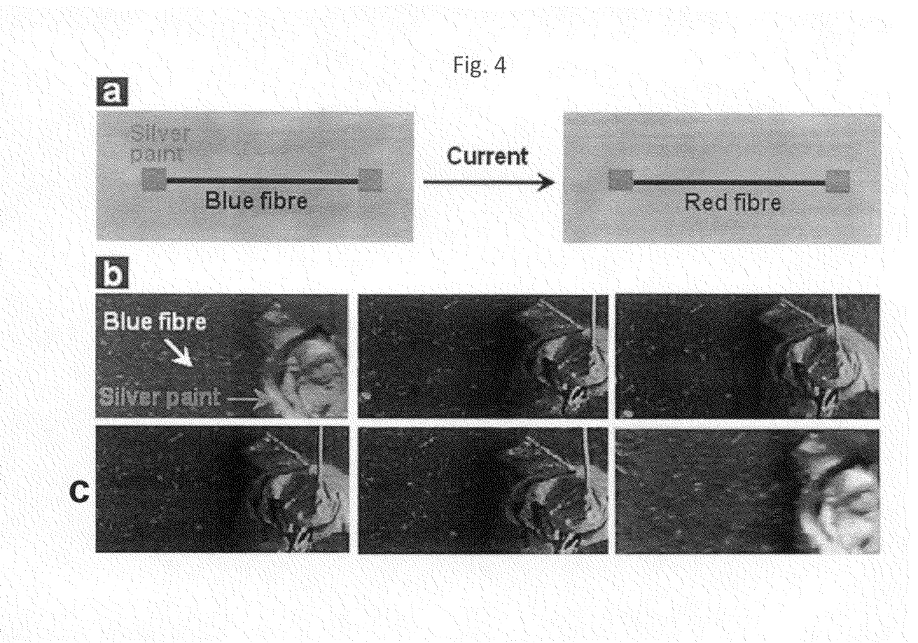

Importantly, CNT/PDA composite fibers rapidly change colors from blue to red under electrical current. FIG. 4 demonstrates experimental set ups and chromatic transitions. The minimum current for chromatic transitions of fibers with diameter of 11 μm is 10 mA at room temperature. In addition, colorimetric reversibility of CNT/PDA fibers can be controlled by varying absolute value of current. For instance, the blue-to-red transition is reversible (see FIG. 4b) when current is lower than 30 mA. Such a reversible color change can continue for cycles (e.g., fourteen cycles for the fiber in FIG. 4b), which is critical for practical sensing applications. Colorimetric responses, percentages of blue-to-red transitions calculated from UV-vis spectra, are 0-0.3% and 10.9-11.4% for blue and red PDA, respectively. Furthermore, the color change can respond to current between “ON” and “OFF” with a speed of 2 seconds, i.e., blue fibers became red in 2 seconds when passed with current and red fibers switched back to blue also in 2 seconds after removal of current. At higher currents, however, the chromatic transition of CNT/PDA fibers is irreversible.

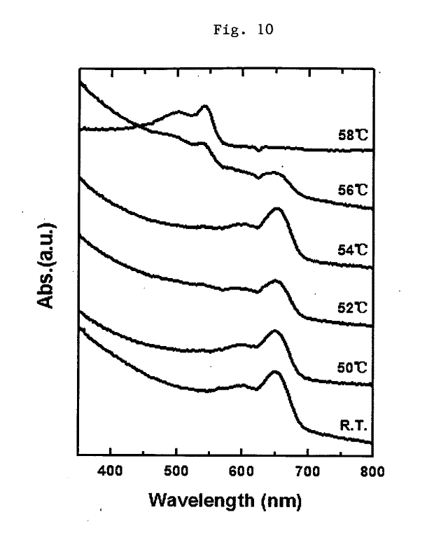

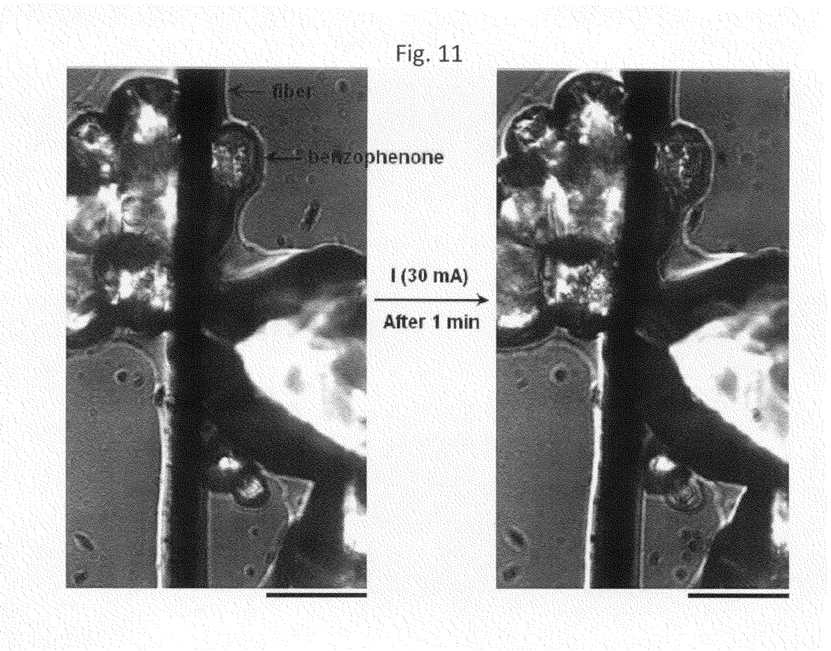

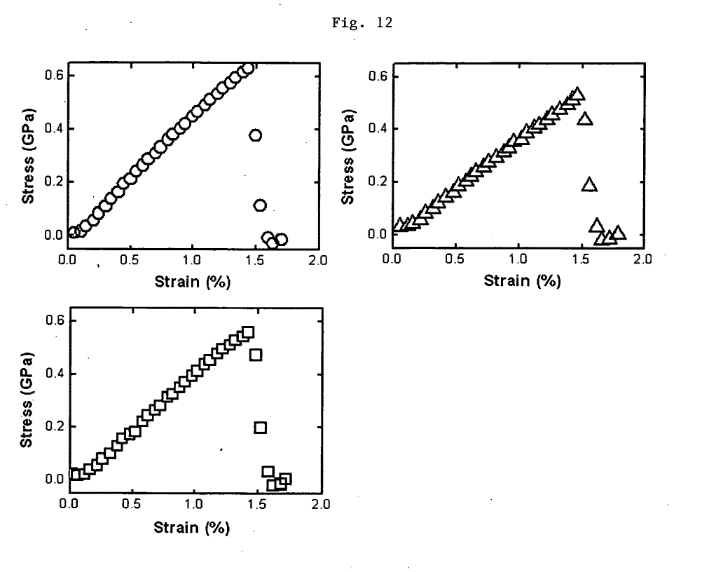

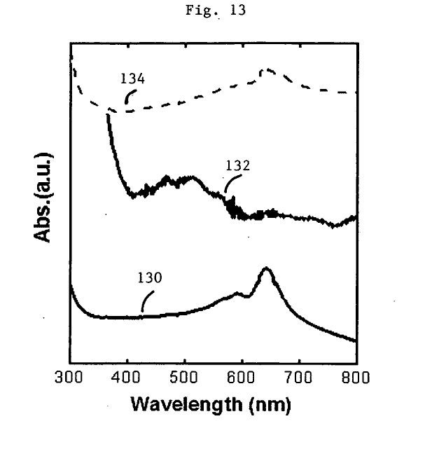

There are several possible reasons responsible for current-induced chromatism of composite fibers. Temperature may increase to induce color changes when current is passing through CNT/PDA fibers. Nevertheless, the following facts may exclude thermally induced color changes. (1) PDA changed colors from blue to red starting from ˜56° C., and the thermochromatism is irreversible, i.e., they remained red after cooled to room temperature (see FIG. 10). In contrast, current-induced chromatism is reversible. (2) No temperature increase has been detected for CNT/PDA fibers when passed with current of 30 mA by infrared thermometer. (3) In order to further investigate the electrochromatism, CNT/benzophenone (benzophenone was found to melt at 44° C.) fibers were fabricated by coating ultra fine benzophenone powder on the outer surface of nanotube fibers. nanotube/benzophenone fibers before and after passed with current of 30 mA were compared under optical microscopy. No melting was observed for benzophenone closely touched to fibers, indicating that temperatures of composite fibers should be lower than 44° C. (see FIG. 11), while thermochromatism happened at ˜56° C. or higher.

The current-induced color change of CNT/PDA fibers is more likely derived from interactions between nanotubes and polymers and unique electrical properties enabled by nanotubes. CNT/PDA fibers exhibit high conductivities with three-dimensional hopping conduction, i.e., electrons hop from one nanotube to another inside a fiber. Therefore, there exist electric fields among neighboring nanotubes, and the electric fields might result in polarization of COOH groups in side chains and conjugated PDA backbones among neighboring nanotubes. The above polarizations decrease π electron delocalization of PDA backbone, which reflects color changes of fibers similar to other reported stimuli (see FIG. 6). In the case of low currents, PDA conformation can return to the original state after removal of current, so the color change is reversible. On another hand, higher currents may destroy the recovery capability of PDA with irreversible chromatism.

Although chromatic response to mechanical stress was previously demonstrated for poly (urethane-diacetylene), it was achieved with large elongation which may limit its sensing applications. Nanotubes are the strongest material ever discovered by mankind, and nanotube fibers exhibit high mechanical strengths. High strengths may provide PDA with mechanochromatism at neglectable elongation. This hypothesis was confirmed by experiments. Color changes of CNT/PDA fibers at high tensile stresses were observed by UV-vis spectrometer. Absorption maxima of blue and red PDAs are located at 600-700 nm and 500-600 nm, respectively. For a CNT/PDA fiber with tensile strength of 0.55 GPa, it remained blue at tensile stress lower than 0.48 GPa and suddenly became red beyond this point (see FIG. 12). If stress was immediately released upon reaching the range of 0.48-0.51 GPa, the red color reverted to blue, i.e., the color transition is reversible. As tensile strength of this composite fiber is 0.55 GPa, we can readily decide application range of composite fiber through color change under tensile stress.

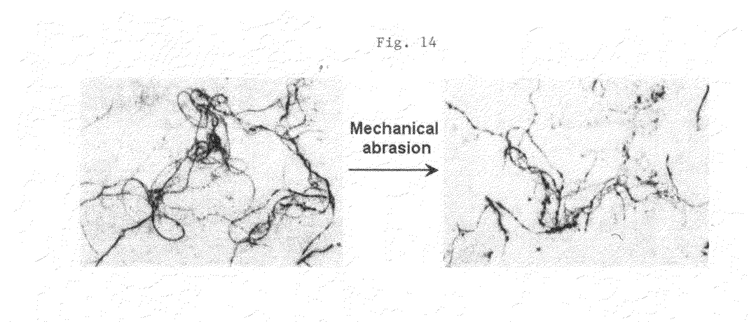

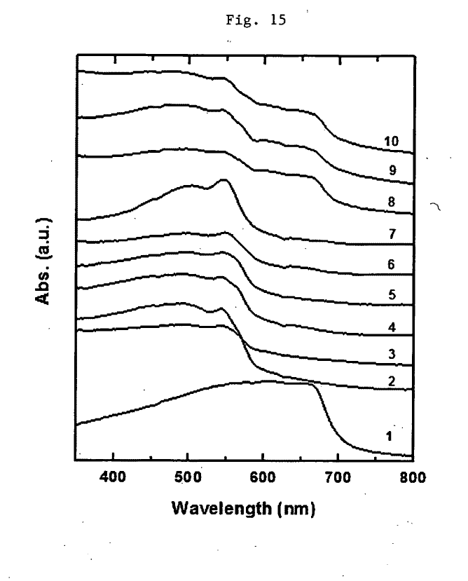

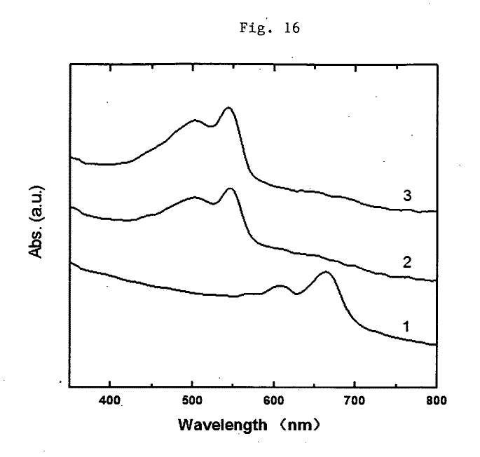

CNT/PDA fibers also chromatically respond to a wide variety of other environmental stimuli such as mechanical abrasion, chemical, and organic vapor. Composite fibers change colors from blue to red under mechanical abrasion in seconds (see FIG. 14). Similarly, when heated to a temperature equal to or higher than 56° C., fibers switch from blue to red in less than a minute. Composite fibers show different responding degrees to chemicals (see FIG. 15). In FIG. 15, the spectra of the as-synthesized fibre is shown at 1. For instance, upon exposure to tetrahydrofuran (2), N,N-dimethyl formamide (4), N,N-dimethyl acetamide (5), and 1-methyl-2-pyrrolidinone (3), fibers completely change colors; when exposed to styrene (6), methyl sulfoxide (7), benzene (8), toluene (9), and methylacrylate (10), fibers partially change colors from blue to red; with water, methanol, ethanol, and ethylene glycol, no color changes have been found. CNT/PDA fibers also change colors in response to organic vapors, such as tetrahydrofuran (2) and N,N-dimethyl formamide (3) (see FIG. 16), where the as-synthesized composite is shown at 1. In an atmosphere of tetrahydrofuran at one atmospheric pressure and room temperature, fibers start to switch colors from blue to red immediately, but the total transition is completed in ˜30 min as the vapor diffusion into the fiber takes time. Compared with tetrahydrofuran vapor, the response to N,N-dimethyl formamide vapor is much slower, e.g., two days. It should be noted that abrasion-, chemical-, or vapor-induced chromatism is not reversible.

In summary, CNT/PDA composite fibers that reversibly change colors in response to electrical current and mechanical stress with negletcable elongation have been synthesized. CNT/PDA fiber can be potentially used as a sensing component that can collectively and chromatically respond to the widest environmental stimuli to date. These CNT/PDA composite fibers are very promising for applications in many fields such as sensors, actuators, and other novel electronic devices.

The present invention is more particularly described in the following examples which are intended as illustrative only, since numerous modifications and variations will be apparent to those skilled in the art.

### Example 1

Preparation of Nanotube Fibers was as has been Reported Elsewhere (See Li et al., Sustained growth of ultralong carbon nanotube arrays for fiber spinning Adv. Mater. 18, 3160-3163 (2006)). For the fabrication of CNT/PDA composite fibers, diacetylenic precursors (e.g., CH₃(CH₂)₁₁C≡C—C≡C(CH₂)₈COOH) were first dissolved in tetrahydrofuran with concentration of 10 mg/mL. Pure nanotube fibers were dipped into the precursor solution, followed by evaporation of solvent at room temperature. Before polymerization, treated fibers were exposed to the open air in a hood for 24 hr. Dry fibers were black originated from nanotubes. Diacetylenic moieties were polymerized at room temperature under ultraviolet light with a wavelength of 254 nm. Polymerization time varied from minutes to hours, depending on fiber diameters. After polymerization, CNT/PDA fibers became blue.

### Example 2

Nanotubes were characterized by scanning electron microscopy (SEM, JEOL 6300FXV operated at 5 kV and Hitachi FE-SEM S-4800 operated at 1 kV) and transmission electron microscopy (TEM, JEOL JEM-2100F and Philips CM30 operated at 200 kV). SEM samples were coated with a thin layer of Au/Pt (5 nm) before observations. TEM samples were prepared by dropcasting nanotube/ethanol solutions onto copper grids in the open air. Mechanical tests were performed by a Shimadzu Table-Top Universal Testing Instrument. Nanotube fibers were mounted on paper tabs with a gauge length of 5 mm. Fiber diameter was measured using a laser-diffraction method and further confirmed by SEM. Raman measurements were performed on Renishaw in Via Reflex with excitation wavelength of 514.5 nm and laser power of 20 mW at room temperature. UV-vis spectrometer was recorded on Shimadz UV-3150.

Although the present invention has been described with reference to specific details, it is not intended that such details should be regarded as limitations upon the scope of the invention, except as and to the extent that they are included in the accompanying claims.

What is claimed is:

1. A composite comprising:
carbon nanotube fibers; and, a polydiacetylene.

2. A nanocomposite comprising:
carbon nanotube fibers and a polydiacetylene.

3. The nanocomposite of claim 2 wherein the polydiacetylene is formed from a polydiacetylene precursor of CH₃(CH₂)₁₁C≡C—C≡C(CH₂)₈COOH.

4. A sensor comprising:
a composite of carbon nanotube fibers and a polydiacetylene, said composite subject to a detectable change in response to a stimuli from among temperature, pH, chemical exposure, mechanical stress; and,
a means of measuring the detectable change.

5. A colorimetric sensor comprising:
a composite of carbon nanotube fibers and a polydiacetylene, said composite subject to a detectable color change in response to an electrical current.

6. The sensor of claim 5 further comprising an instrumental means of measuring the detectable color change.
